(19) United States
(12) Patent Application Publication
(10) Pub. No.: US 2010/0127511 A1
(43) Pub. Date: May 27, 2010

(54) VEHICLE DOOR LATCH HAVING A POWER LOCK-UNLOCK MECHANISM

(76) Inventors: Francisco Javier Vasquez, Cd Juarez Chihuahua (MX); Alfredo Martinez, Cd. Juarez Chihuahua (MX); Alcala Moises, Cd. Juarez Chihuahua (MX)

Correspondence Address: CANTOR COLBURN, LLP, 20 Church Street, 22nd Floor, Hartford, CT, 06103, US

(21) Appl. No.: 12/572,842

(22) Filed: Oct. 2, 2009

Related U.S. Application Data
(63) Continuation-in-part of application No. 12/324,103, filed on Nov. 26, 2008.

(51) Int. Cl. E05C 3/06

(52) U.S. Cl. 292/201

(57) ABSTRACT

A door latch having a forkbolt that moves between a latched position and an unlatched position is provided. It includes a detent for holding the forkbolt in the latched position, and a power operated lock mechanism for moving the door latch to an unlock or lock position. It further comprises a first rotatable locking lever moveable between an unlocked and locked position and in operable communication with the detent through an intermittent lever; a second rotatable locking lever in operable communication with the first rotatable locking lever; a motor driven actuator engaging the second rotatable locking lever; and an actuator pin disposed between the motor driven actuator and the second rotatable locking lever for rotating the second rotatable locking lever.

### CROSS REFERENCE TO RELATED APPLICATIONS

This application is a continuation-in-part of application Ser. No. 12/324,103 filed on Nov. 26, 2008, the disclosure of which is incorporated by reference herein, in its entirety.

### BACKGROUND OF THE INVENTION

An automotive closure, such as a door for an automobile passenger compartment, is hinged to swing between open and closed positions and conventionally includes a door latch that is housed between inner and outer panels of the door. The door latch functions in a well known manner to latch the door when it is closed and to lock the door in the closed position or to unlock and unlatch the door so that the door can be opened manually.

In general terms, the door latch has a forkbolt that engages a striker in the door jamb to latch the door when it is closed and a spring biased detent lever that engages and holds the forkbolt in the latched position. The door latch also typically has a release mechanism for moving the detent to a position releasing the forkbolt so that the door can be unlatched and opened and a lock-unlock mechanism for disabling the release mechanism to prevent unauthorized unlatching of the door. U.S. Pat. No. 6,053,543 granted to Arabia, Jr. et al. on Apr. 25, 2000, which is incorporated by reference herein, shows a typical door latch, as known in the prior art.

A door latch also includes an independent lock and unlock mechanism sometimes this includes an intermittent lever and the door latch is power operated. Generally, a bell crank lever engages a screw that rotates when driven by an electric motor. The rotation of the screw causes an axial movement that ultimately drives a slide up and down. The slide is connected to a bell crank lever having multiple moving parts and pivot points for allowing a detent in and out of engagement with a forkbolt, causing the forkbolt to move between a latched and an unlatched position.

A door lock, especially when placed in a vehicle, should be robust in that it is capable of operating in extreme environments and capable of operating for years over multiple duty cycles. It should also be capable of a manual lock or un-lock without having to back-drive the motor or other power operated devices.

### SUMMARY OF THE INVENTION

The present invention provides a simple power operated lock-unlock mechanism. It has less moving parts and pivots than other latches. This assures that the lock is capable of performing in extreme environments for many years. The mechanism also provides a lost motion aspect that allows the lock-unlock mechanism to be operated manually in the event of power failure to the power operated device.

A door latch having a forkbolt that moves between a latched position and an unlatched position is provided. It includes a detent for holding the forkbolt in the latched position, and a power operated lock-unlock mechanism for moving the door latch to a lock or unlock position. It further comprises a first rotatable locking lever moveable from a locked position to an unlocked or locked position and in operable communication with the detent through an intermittent lever; a second rotatable locking lever in operable communication with the first rotatable locking lever; a motor driven actuator engaging the second rotatable locking lever; and an actuator pin disposed between the motor driven actuator and the second rotatable locking lever for rotating the second rotatable locking lever.

In another aspect of the invention, a power operated locking mechanism for a door latch is provided. It comprises a first rotatable locking lever moveable from a locked position to an unlocked position. A second rotatable locking lever in operable communication with the first rotatable locking lever and having a first portion extending therefrom is also provided. A motor driven actuator including an actuator pin extending therefrom is provided. The actuator pin engages the second rotatable locking lever at the first portion so as to allow movement of the second rotatable locking lever without movement of the motor driven actuator.

In yet another aspect of the invention, a door latch having a forkbolt that moves between a latched position and an unlatched position is provided together with a detent for holding the forkbolt in the latched position, and a power operated lock-unlock mechanism for moving the door latch to a lock or unlock position. It includes a first rotatable locking lever moveable from a locked position to an unlocked position, an intermittent lever in operable communication with the detent and an unlatching lever. A second rotatable locking lever is in operable communication with the first rotatable locking lever. An axially extending motor driven actuator includes an actuator pin having a portion extending from the actuator at an angle from the axis, the actuator pin engaging the second rotatable locking lever.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a cross sectional view showing one aspect of the present invention.

FIG. 2 is a pictorial view of the door latch, in a unlocked position, in accordance with the present invention;

FIG. 3 is a pictorial view of the door latch of FIG. 2, in a locked position, in accordance with the present invention; and

FIG. 4 is a pictorial view showing another aspect of the present invention.

### DETAILED DESCRIPTION OF THE INVENTION

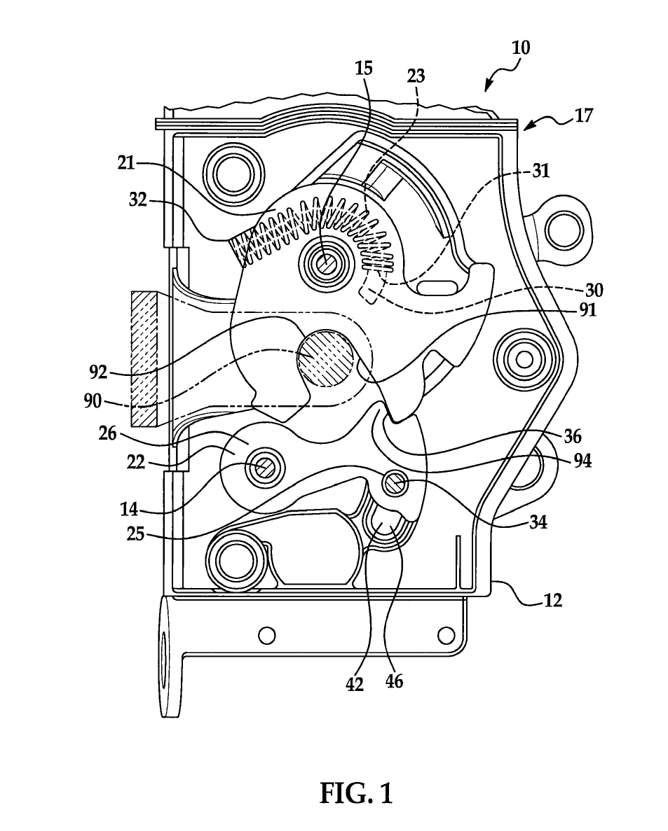

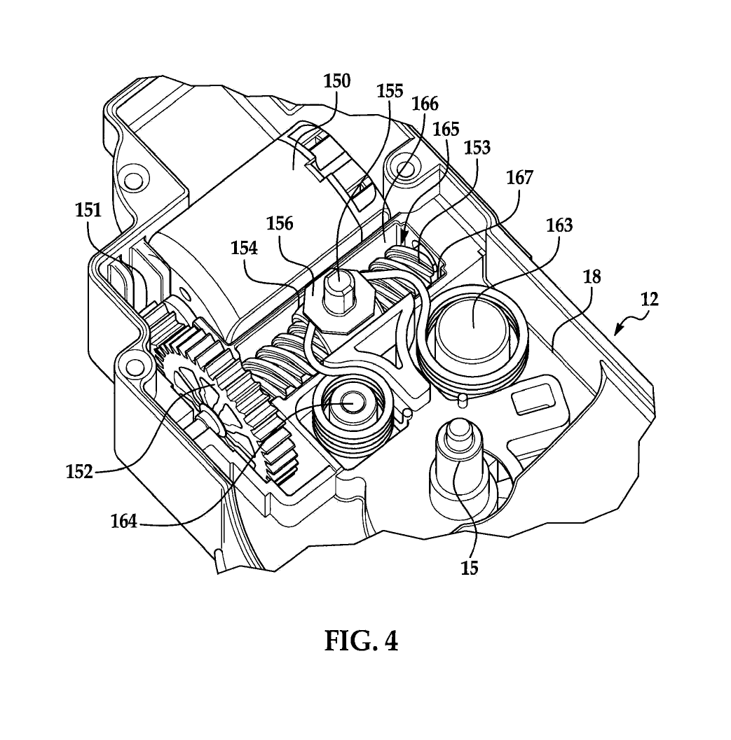

Referring now to FIGS. 1 through 4, where the invention will be described with reference to specific embodiments, without limiting same, a door latch 10 is located within a housing enclosure 12. The housing 12 includes two flanged studs 14 and 15 that are inserted through the housing 12, and capture both a face plate and a back cover (not shown) by being flanged over holes in the face plate and back cover to form a forward compartment 17 and a rearward compartment 18 of door latch 10.

Door latch 10 has a latch mechanism comprising a forkbolt 21 and a cooperating detent 22 that are located in the forward compartment 17 and pivotally mounted on the forward portions of studs 15 and 14, respectively. Forkbolt 21 is biased clockwise by a compression spring 23 that is disposed in a curved slot (not shown) in housing 12 behind forkbolt 21. Spring 23 engages a lateral lug 30 of forkbolt 21 at a first end 31 and an end wall (not shown) of the curved slot at a second end 32.

Detent 22 engages a lateral pin 34 through an opening 25 within the detent 22 that extends between a first side 26 and a second side 27 of the detent. Lateral pin 34 is rotatable within opening 25 and extends through a housing slot 42 that defines a travel path 46 for lateral pin 34 and into the rearward compartment 18. Door latch 10 has a release mechanism 51 for manually releasing or unlatching the latching mechanism. Specifically, releasing mechanism includes an unlatching lever 52, shown retained on first stud 14 and being adapted to rotate about first stud 14. Unlatching lever 52 has an intermittent lever slot 53 extending between rear side 54 and front side 55 of the unlatching lever 52. Engaging intermittent lever slot 53 and pivotably engaging unlatching lever 52 is an intermittent lever 60. An intermediate portion 61 of intermittent lever 60 includes lateral pin 34. Extending therefrom is a first arm portion 62 having a first lever pin 63 that engages intermittent lever slot 53. A second arm portion 64 also extends from intermediate portion 61. Extending from second arm portion 64 is a second lever pin 65 that engages a slot 67 within a power operated lock-unlock mechanism 110, shown in an exemplary embodiment herein as a three-piece power operated lock-unlock mechanism 110.

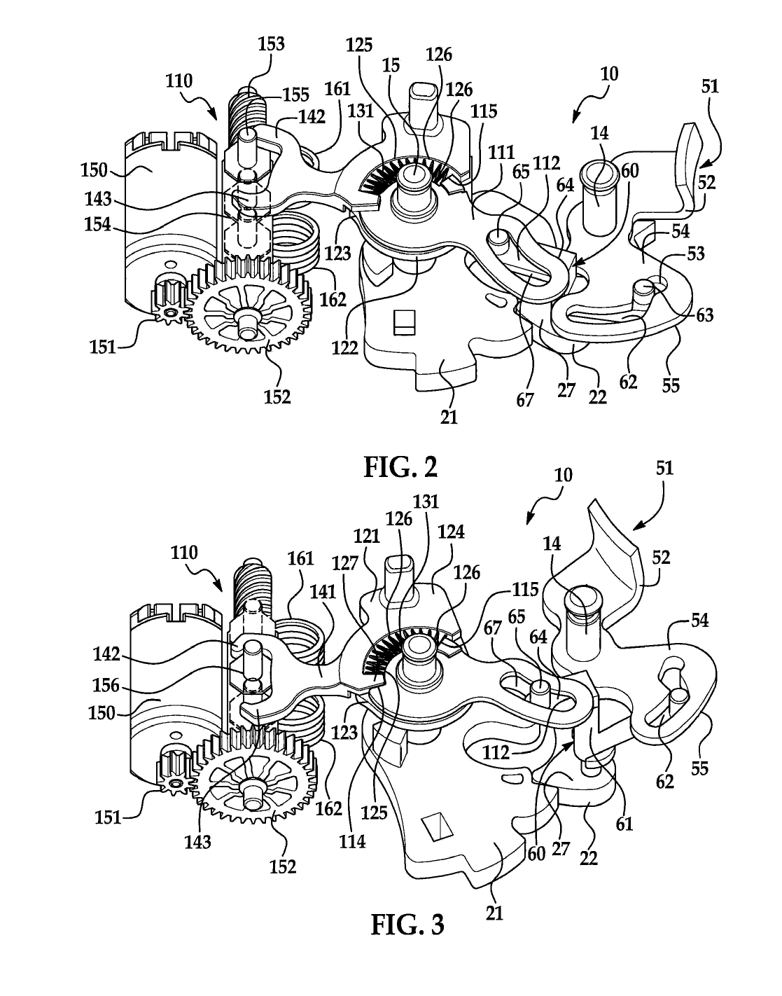

As is well known and can be seen from the Figures, detent 22 engages forkbolt 21 at a primary latch shoulder 36 and holds forkbolt 21 in a primary latched position, against the bias of springs (not shown). Detent 22 is rotated counter-clockwise from a latched position and out of latched engagement with the forkbolt 21 to a release or unlatched position when the release mechanism is operated. This releases forkbolt 21 so that it is free to rotate in a conventional manner from the latched position to the unlatched position allowing a vehicle door to be opened. In FIGS. 2 and 3, forkbolt 21 is still in the primary latched position.

Door latch 10 includes the power operated lock-unlock mechanism 110. Power operated lock-unlock mechanism 110 includes a first rotatable locking lever (or upper locking lever) 111 movable from a resting or unlocked position shown in FIG. 2 to a locked position shown in FIG. 3. As shown, first rotatable locking lever 111 is in operable communication with detent 22 through intermittent lever 60. Specifically, second lever pin 65 slidingly engages a slot 112 located within rotatable locking lever 111. Rotatable locking lever 111 is capable of pivotable movement about stud 15 and is located within rearward compartment 18 of housing 12. Locking lever 111 also includes shoulder portions 114 and 115 that engage a second rotatable locking lever (or lower locking lever) 121.

Second rotatable locking lever 121 includes a saucer portion 122 through which stud 15 extends, thus also allowing rotation of second locking lever 121. The rearward face 123 of saucer portion 122 supports and is in sliding engagement with a forward facing face of locking lever 111. Extending both rearward and outwardly from the saucer portion 122 is a handle portion 124 having a groove 125 therein that is open at a first end 126 and defined by a finger 127 at its opposite end. A resilient member, such a compression spring 131 sits within groove 125 with one end of spring 131 bearing against finger 127 and the other end or spring 131 bearing against shoulder portion 115.

Extending from the handle portion 124 of locking lever 121 is a fork portion 141 having tines 142 and 143. A motor 150 that includes a drive gear 151 drives an actuator gear 152 that causes an actuator to rotate, in this case screw stock 153 having threads thereon. Threaded on actuator 153 is an actuator and nut 154 having an actuator pin 155 extending therefrom. Actuator pin 155 extends between tines 142 and 143 of fork portion 141. Actuator pin 155 includes a collar 156 for engaging at least one, and as shown, the legs of two resilient members comprising torsion springs 161 and 162. Torsion springs 161 and 162 keep nut 154 and actuator pin 155 centered. Springs 161 and 162 are seated within spring seats 163 and 164, respectively of housing 12. Actuator 153 sits in a well 165 of housing 12, which includes opposite interior sides 166 and 167. The outside diameter of nut 154 bears against interior sides 166 and 167 in such a manner that rotation of actuator 153 causes nut 154, shown in phantom in FIGS. 2 and 3, to move axially along the threads of actuator 153 and thus retains actuator pin in the upright position shown in FIGS. 2 and 3.

The actuator pin 155 has an upper portion that has an outside diameter. Tines 142 and 143 of fork portion 141 are adapted to engage actuator pin 155 at its upper portion when actuator pin 155 moves axially. In an exemplary embodiment, actuator pin 155 has an outside diameter and tines 142 and 143 have a first distance therebetween. The first distance is greater than the outside diameter plus the travel of pin 155 between the locked and unlocked position.

Movement of the door lock from the unlocked position of FIG. 2 to the locked position of FIG. 3 will now be described. Driving motor 150 causes drive gear 151 to rotate, which in turn drives actuator gear 152 and threaded actuator 153, shown as a jackscrew. As threaded actuator 153, rotates nut 154 translates axially along threaded actuator 153, thus moving actuator pin 155 in an axial direction—shown in phantom in FIGS. 2 and 3. This axial movement causes one of tines 142 or 143 to contact the upper portion of actuator pin 155, thus causing fork portion 141 and locking lever 121 and finger 127 to bear against compression spring 131 within groove 125, the other end of compression spring 131 contacting shoulder portion 115 of rotatable locking lever 111. Clockwise rotation of rotatable locking lever 111 allows second lever pin 65 to move within the slot 112, so that the latching mechanism can work. Thus the latching mechanism can be operated to move intermittent lever 60 out of locking engagement with the primary latch shoulder 36 of forkbolt 21 by causing lateral pin 34 to bear within opening 25. Compression spring 23 causes forkbolt 21 to rotate clockwise to an unlatched position. During this movement, striker pin 90 moves out of a rear portion 92 of throat 91, thus releasing striker pin 90.

In a like manner, when the door latch 10 is in an unlatched and unlocked condition, forkbolt 21 is poised to receive a striker pin 90. When a door having latch 10 is shut, the striker pin 90 enters the throat 91 of forkbolt 21, engages the rear portion 92 of throat 91 and rotates forkbolt 21 counterclockwise against the bias of compression spring 23 until forkbolt 21 is rotated to the primary latched position shown in FIGS. 1 and 2, where forkbolt 21 captures striker pin 90 in throat 91. Forkbolt 21 is held in the latched position by catch 94 of detent 22 engaging primary latch shoulder 36 of forkbolt 21. The motor 150 then can be actuated by a secondary operation in order to lock the door latch 10. While the invention has been described in detail in connection with only a limited number of embodiments, it should be readily understood that the invention is not limited to such disclosed embodiments. Rather, the invention can be modified to incorporate any number variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A door latch having a forkbolt that moves between a latched position and an
unlatched position, a detent for holding the forkbolt in the latched position, and a power operated lock mechanism for moving the door latch to an unlock position comprising:
a first rotatable locking lever moveable from a locked position to an unlocked position and in operable communication with said detent through an intermittent lever;
a second rotatable locking lever in operable communication with said first rotatable locking lever;
a motor driven actuator engaging said second rotatable locking lever; and
an actuator pin disposed between said motor driven actuator and said second rotatable locking lever for rotating said second rotatable locking lever.

2. The door latch of claim 1, wherein said second rotatable locking lever and said first rotatable locking lever each rotate about a common pivot pin.

3. The door latch of claim 1, wherein one of said first rotatable locking lever and said second rotatable locking lever rotates relative to the other of said first or second rotatable locking lever.

4. The door latch of claim 3, wherein a resilient member is disposed between said first rotatable locking lever and said second rotatable locking lever.

5. The door latch of claim 1, wherein said second rotatable locking lever includes a fork extending therefrom, said fork engaging said actuator pin.

6. The door latch of claim 5, wherein said fork includes at least two tines, said actuator pin disposed between said at least two tines.

7. The door latch of claim 6, wherein said pin has an outside diameter and said two tines have a first distance therebetween, said first distance greater than said outside diameter plus a travel of said pin between said locked and unlocked position.

8. The door latch of claim 1, wherein said actuator pin includes a portion for moving axially along said motor driven actuator.

9. The door latch of claim 1, wherein said actuator pin includes a threaded portion for moving axially along a threaded screw portion of said motor driven actuator.

10. The door latch of claim 1, including at least one resilient member in engagement with said actuator pin.

11. The door latch of claim 1, including at least two resilient members in engagement with opposite sides of said actuator pin.

12. A power operated locking mechanism for a door latch comprising:
a first rotatable locking lever moveable from a locked position to an unlocked position;
a second rotatable locking lever in operable communication with said first rotatable locking lever and having a first portion extending therefrom; and
a motor driven actuator including an actuator pin extending therefrom, said actuator pin engaging said second rotatable locking lever at said first portion so as to allow movement of said second rotatable locking lever without movement of said motor driven actuator.

13. The locking mechanism of claim 12, wherein said first portion includes a fork, said fork engaging said actuator pin.

14. The locking mechanism of claim 13, wherein said fork includes at least two tines, said actuator pin disposed between said at least two tines.

15. The locking mechanism of claim 14, wherein said pin has an outside diameter and said two tines have a first distance therebetween, said first distance greater than said outside diameter plus a travel of said pin between said locked and unlocked position.

16. A door latch having a forkbolt that moves between a latched position and an
unlatched position, a detent for holding the forkbolt in the latched position said door lock comprising:
a first rotatable locking lever moveable from a locked position to an unlocked position;
an intermittent lever in operable communication with said detent and an unlatching lever;
a second rotatable locking lever in operable communication with said first rotatable locking lever; and
an axially extending motor driven actuator including an actuator pin have a portion extending from said actuator at an angle from said axis, said actuator pin engaging said second rotatable locking lever.

17. The door latch of claim 16, wherein said actuator pin includes a portion for moving axially along said motor actuator.

18. The door latch of claim 16, wherein said actuator pin includes a threaded portion for moving axially along a threaded screw portion of said motor driven actuator.

19. The door latch of claim 16, including at least one resilient member in engagement with said actuator pin.
